(19) United States
(12) Patent Application Publication
(10) Pub. No.: US 2016/0028876 A1
(43) Pub. Date: Jan. 28, 2016

(54) MOBILE APPLICATION AND SYSTEM FOR PERFORMANCE RECORDATION AND DISTRIBUTION

(71) Applicant: PEERPOINT LLC, Georgetown, ME (US)

(72) Inventor: Jason E. BROWN, Georgetown, ME (US)

(73) Assignee: Peerpoint LLC

(21) Appl. No.: 14/805,967

(22) Filed: Jul. 22, 2015

Related U.S. Application Data
(60) Provisional application No. 62/028,118, filed on Jul. 23, 2014.

(51) Int. Cl. H04M 1/725; H04W 4/00; H04W 4/06

(52) U.S. Cl. CPC H04M 1/72558; H04W 4/06; H04W 4/003

(57) ABSTRACT

The present disclosure relates to a system, software applications and methodologies enabling users to sing alone, with others, record their performances and share recordings with others.

### CROSS-REFERENCE TO RELATED APPLICATION

The present application claims priority under 35 U.S.C. §119 to U.S. patent application Ser. No. 62/028,118, filed Jul. 23, 2014, the entire contents of which being incorporated herein by reference.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The present disclosure relates to systems, software applications and methods that enable users to sing alone, with others, record their performances and share recordings with others.

### SUMMARY

The present disclosure relates to a system, software applications and methodologies enabling users to sing alone, with others, record their performances and share recordings with others.

### BRIEF DESCRIPTION OF THE FIGURES

A more complete understanding of the disclosed embodiments and the utility thereof may be acquired by referring to the following description in consideration of the accompanying drawings, in which like reference numbers indicate like features, and wherein:

FIG. 1 illustrates one example of a system provided in accordance with the disclosed embodiments that enable users to sing alone, with others, record their performances and share recordings with others.

FIG. 2 illustrates one example of a splash screen with a logo associated with the launching of the mobile application.

FIG. 3 illustrates one example of a login screen that may be displayed in association with the launching of the mobile application.

FIG. 4 illustrates one example of a profile screen that may be displayed an enable customization of a user profile in the mobile application.

FIG. 5 illustrates one example of a photo screen that may be displayed an enable customization of a user profile photo in the mobile application.

FIG. 6 illustrates one example of a home screen that may be displayed in the mobile application with a listing of nearby concerts provided.

FIG. 7 illustrates one example of a home screen that may be displayed in the mobile application.

FIG. 8 illustrates one example of an APPLE TV® Connection screen that may be displayed in the mobile application.

FIG. 9 illustrates one example of an APPLE TV® Connection Success message that may be displayed in the mobile application.

FIG. 10 illustrates an example of functionality associated with the home screen with the active concert tab with the list of singers and the highlighted host, choose song and leave concert buttons by clicking on the next button.

FIG. 11 illustrates an example of a message displayed if APPLE TV® is not found.

FIG. 12 illustrates an example of a waiting for stereo connection message that may be displayed in the mobile application.

FIG. 13 illustrates an example of a stereo connection success message that may be displayed in the mobile application.

FIG. 14 illustrates an example of a library screen that may be displayed in the mobile application.

FIG. 15 illustrates an example of a voting screen that may be displayed in the mobile application.

FIG. 16 illustrates an example of a landscape view of the lyrics screen that may be displayed in the mobile application.

FIG. 17 illustrates an example of a portrait view of the lyrics screen that may be displayed in the mobile application.

FIG. 18 illustrates an example of a post-song screen that may be displayed in the mobile application.

FIG. 19 illustrates an example of a joining concert screen that may be displayed in the mobile application.

FIG. 20 illustrates an example of a menu button, through which a user may be able to get access to the application menu via the home screen.

FIG. 21 illustrates an example of a history screen, which may display songs previously used in the mobile application.

FIG. 22 illustrates another example of the songs on a user's library screen in the mobile application.

FIG. 23 illustrates an example of a history item screen which may be displayed in the mobile application.

FIG. 24 illustrates an example of a help section screen that may be displayed in the mobile application.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Functionality described herein may be provided using one or more software applications running on one or more computer processors. For example, some disclosed functionality may be implemented using a mobile software application downloaded to and running on a mobile devices such as a tablet, Ipad®, Ipod®, smart phone or feature rich mobile phone, e.g., an Iphone®. In addition, and or alternatively, some disclosed functionality may be implemented on one or more servers accessible via the mobile device via at least one communication network, e.g., a wireless network coupled to the Internet. With this understanding in mind, it should be appreciated that the location of the software applications performing the disclosed embodiments may vary.

Various terms are used throughout this disclosure. For example, a user refers to any person who can be either Host or Singer during a concert session. Thus, the Host and Singer are sub-roles for a user. A Host may be a person who starts and hosts a concert; whereas, a Singer may be a person who joins a concert started by a Host.

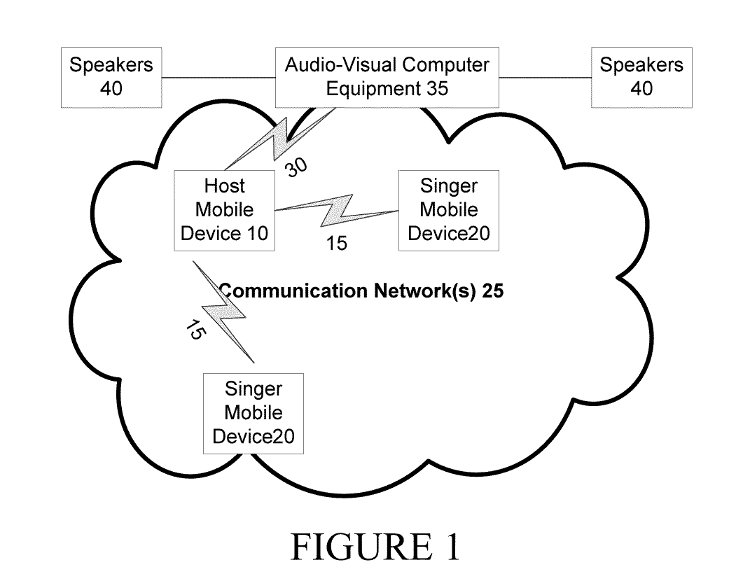

The present disclosure relates to systems, software applications and methods that enable users to sing alone, with others, record their performances and share recordings with others. The disclosed systems, software applications and methodologies provide a workspace in which a host and singer(s) may interact. Thus, as illustrated in FIG. 1, host device 10 of a host user may be coupled (via a communication link 15) to one or more singer's mobile devices 20 via one or more communication networks 25 (e.g., Wireless Local Area Networks (WLANs), Local Area Networks (LANs), cellular networks, WIFI, BLUETOOTH® etc.). Likewise the host device 10 may be coupled via a communication link 30 (such as BLUETOOTH® or a wired link) to a stereo or general or special purpose computer 35, e.g., sound system equipment, audio visual equipment, an APPLE TV®, etc. that includes or is further coupled to one or more speakers 40. In this manner, a selected song may be output from the stereo or general or special purpose computers via the one or more speakers to the host and singer(s). Simultaneously, software running on the host and singer(s) mobile devices may output data enabling the host and/or singer(s) to sing lyrics for an output song (e.g., lyrics). In connection with output via the mobile devices and via the one or more speakers, the host device may also be further configured to record the host and/or singer(s) performance of the song singing the lyrics of the output song. In this way, the mobile application running on the user's devices enables the users to work collaboratively to select, perform and record performance of songs via the disclosed embodiments.

The workspace provided by the disclosed embodiments may be implemented using a mobile application, e.g., an iPhone® application, for example, one that may connect to APPLE TV®. A mobile application used to provide the workspace may support iOS 5.1+, be compatible with APPLE TV®, support portrait and landscape (for ‘Lyrics’ screens, as explained herein) views, be user-friendly and easy-to-use, be fun and have high quality graphics and enable users to be able to get connected and start singing with as few clicks as possible.

Users may have the ability to view a splash screen(s), sign in with Facebook® or Twitter®, skip profile configuration operations, start a concert, manage connection settings (including using APPLE TV® connections and stereo connections), select a song (including via viewing a library, viewing purchased songs, viewing iTunes® songs, submit a song, and skip various functionality to enable the user to vote for a song. The users may also have the ability to view songs, select and submit a song and skip operations to vote for a song from a library view screen. Using the provided workspace, users are able to participate in song election, view a list of suggested songs, vote for a song, cancel a vote and/or submit another song. Further, The users may manage song playback, pause/un-pause a song, change volume (for voice output and/or music output), replay a song and share recorded performance data and other data via one or more social media channels (e.g., Facebook® and/or Twitter®).

As part of the workspace functionality provided to a user joining a concert, the user has the ability to view a list of concerts to join, select a concert, and join a concert. Additionally, the user has the ability to select a song, participate in song election, and manage song playback, as explained above. The user may also have the ability to view, edit, manage and delete a list of history items and details (including song details and/or a list of singers) and listen to and share recordings, as explained above. The workspace may also enable a user to manage profile data including user information (user name, user photo, social media channel photo and data), social media account settings and default output volume (including voice and/or music).

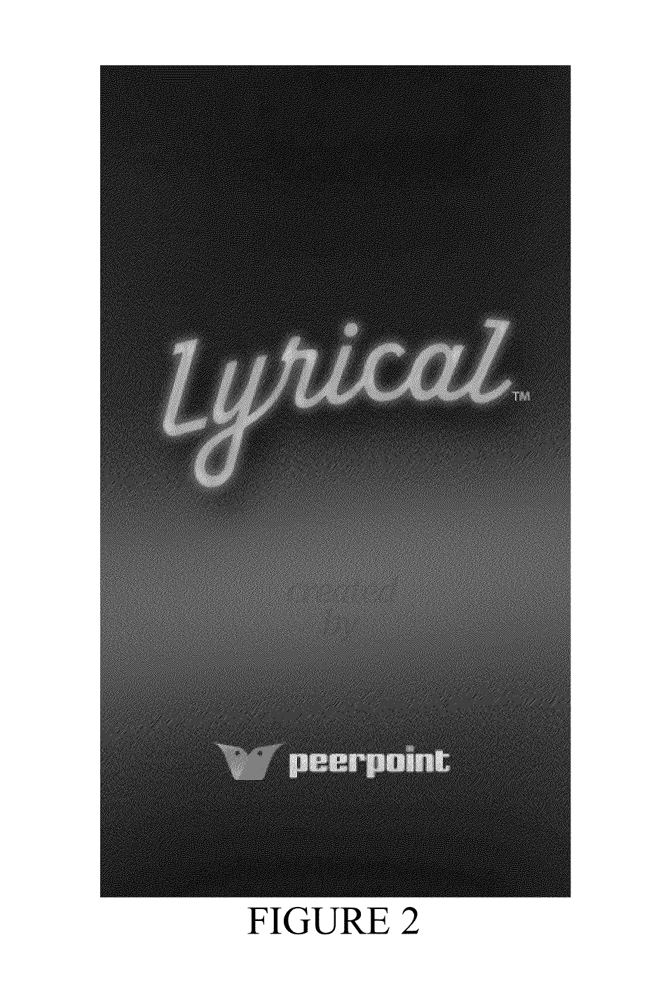

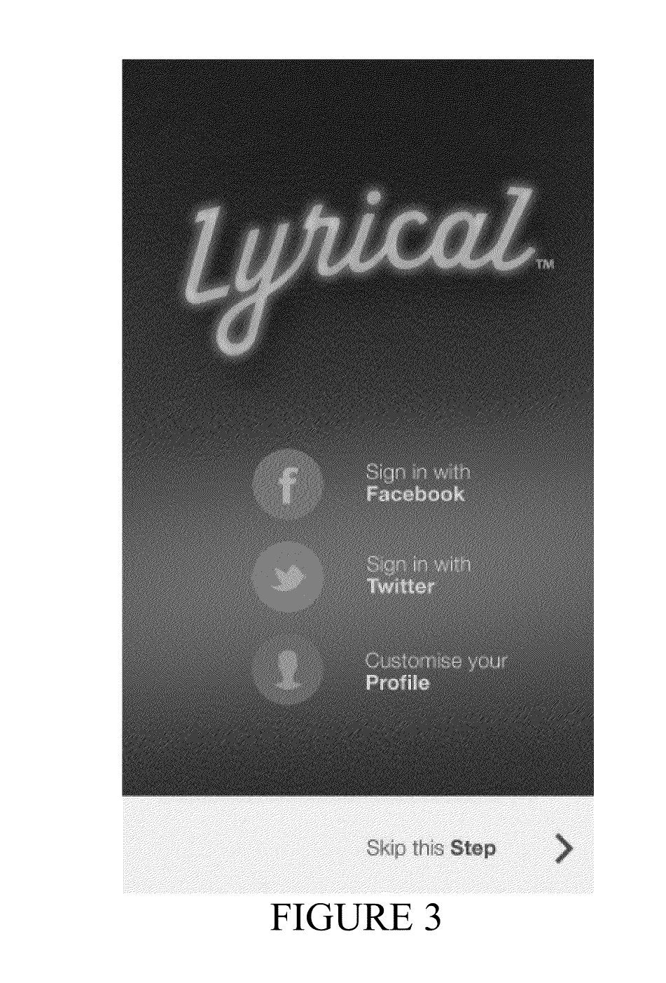

When a user starts the mobile application, the ‘Splash’ screen with a logo may be displayed, as shown in FIG. 2. If it is the first start of the application, the user may be redirected to the ‘Login screen, an example of which being illustrated in FIG. 3. Using that screen, the workspace provides the user with various functionality options. For example, the user may be able to use his/her Facebook® or Twitter® profile data (photo, name) for the profile customization process by clicking on the corresponding element and signing in to the corresponding account. As a result, the user may be redirected to a ‘Profile Customization’ screen with photo and name inserted.

Additionally, the user may be able to go straight to the ‘Profile Customization’ screen by clicking on the ‘Customize your Profile’ button. As a result, the user may be redirected to the ‘Profile Customization’ screen where he/she may be able to input this information manually.

Further, the user may be able to skip the whole profile customization process by clicking on the ‘Skip this Step’ button. As a result, the user may be redirected to the ‘Home’ screen with the default name ‘Singer’ and without photo. The user may be able to configure his/her profile later via profile settings.

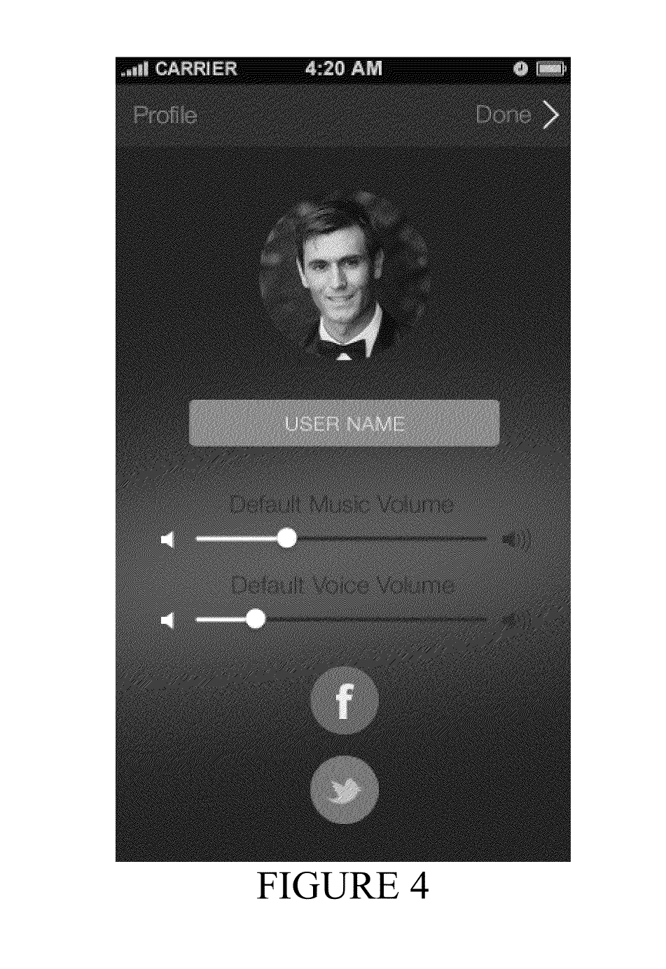

On the ‘Profile’ screen the user may be suggested to customize his/her name, photo, social networks, default music and voice volume, as illustrated in FIG. 4.

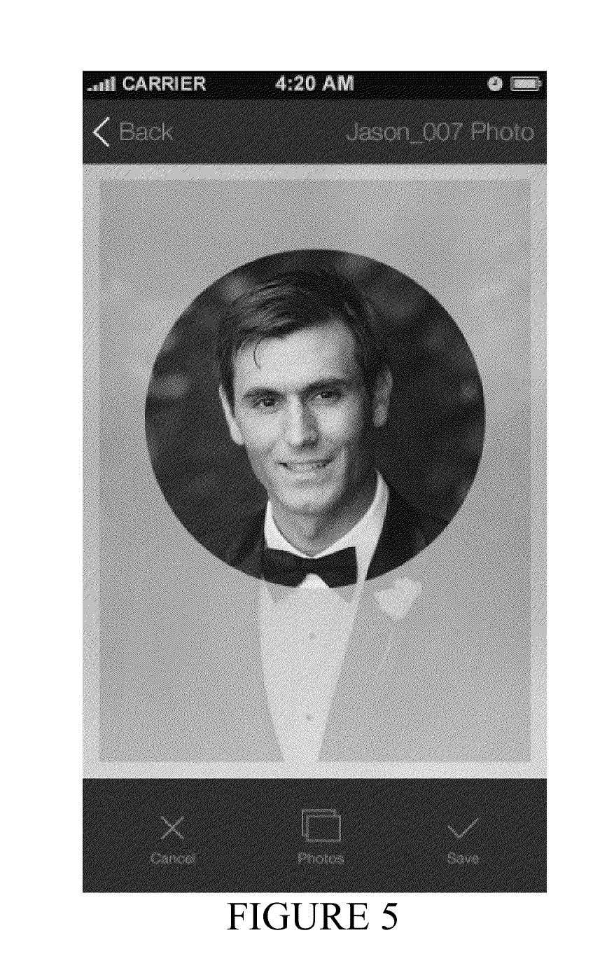

The user may be able to go to the ‘Photo’ screen by clicking on the photo. A ‘Photo Customization’ screen may look as shown in FIG. 5.

The user may be able to move and scale the photo. The user may be able to select the source for photo by clicking on the ‘Photos’ button at the bottom center. On click the special form may be called out with various options. For example, a Photo Album option may lead to the photo album where the user may be able to choose the photo. After the required photo is selected, the user may be redirected back to the ‘Photo’ screen with the updated photo. A Facebook® option may enable a user to use a Facebook® photo if the corresponding connection was configured. Otherwise, this button may be disabled. A Twitter® option may enable the user to use a Twitter Photo® if the corresponding connection was configured. Otherwise, this button may be disabled.

A user selecting Cancel—closes this form. The user may be able to delete the photo by clicking on the ‘Delete’ button at the bottom left corner. The user may be able to confirm the photo and return to the ‘Profile’ screen by clicking on the ‘Save’ button at the bottom right corner.

The user may be able to go back to the ‘Profile’ screen by clicking on the back button. The user may be able to enter his/her name. The user may be able to configure default music and voice volume. The user may be able to configure the social network connection (Facebook® and/or Twitter®). The user has to sign into Facebook® and/or Twitter® account to get an access to sharing features.

The user may be able to complete the customization process by clicking on the ‘Done’ button. As a result, the user may be redirected to the ‘Home’ screen with the active ‘Concert’ tab. If it is not the first start of the application, the user may be redirected straight to the ‘Home’ screen with the active ‘Concert’ tab.

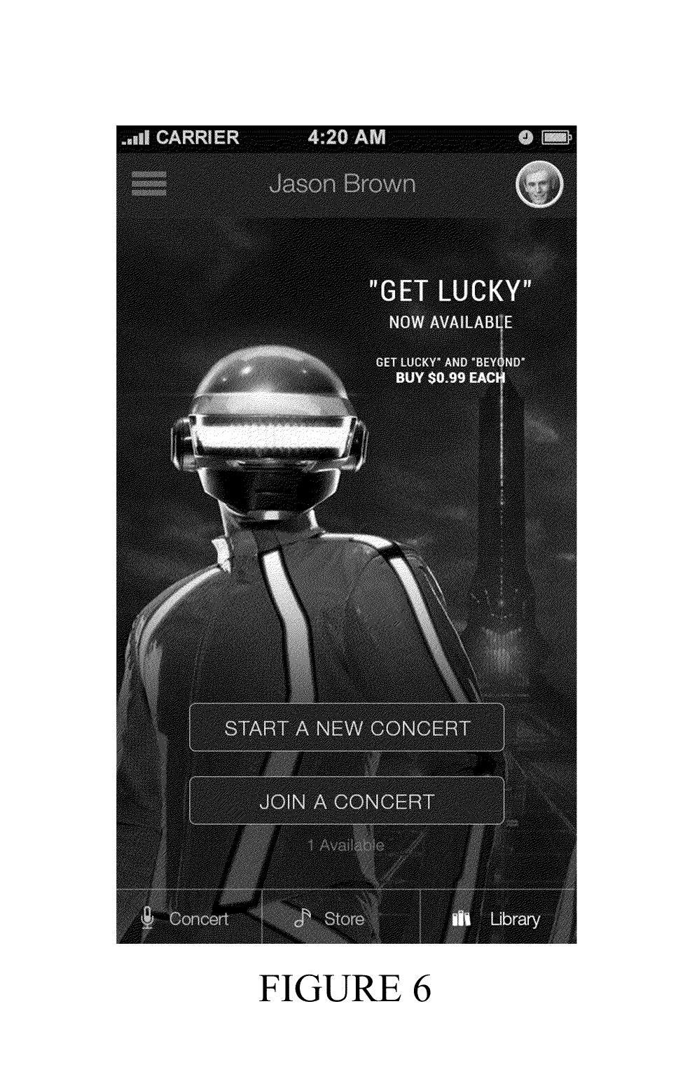

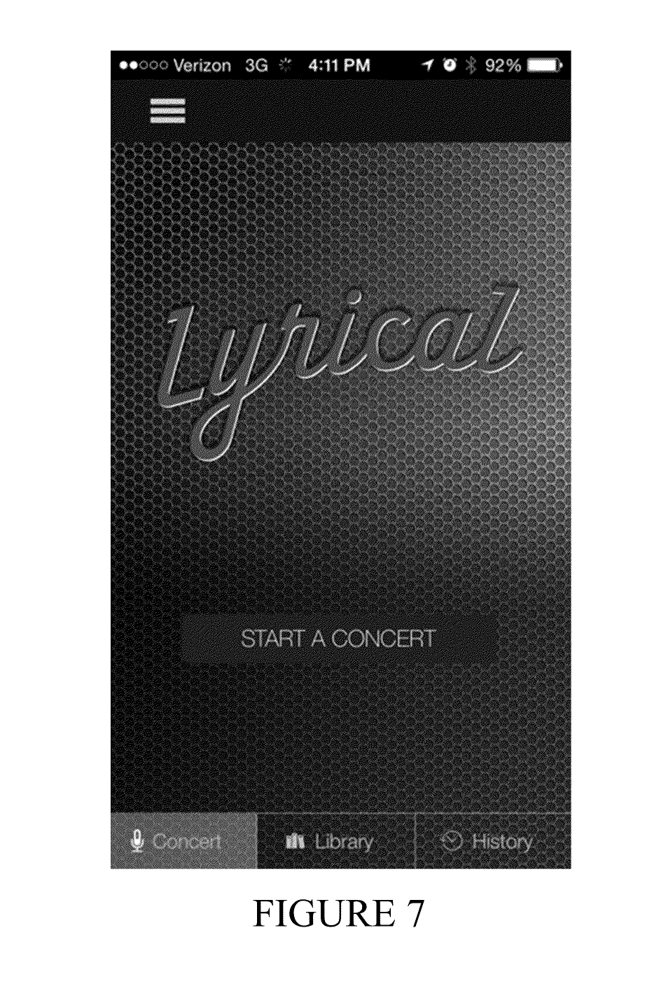

On the start there can be two states of the ‘Home’ screen with an active ‘Concert’ tab, e.g., the ‘Home’ screen with available concerts nearby (an example of which being illustrated in FIG. 6) or the ‘Home’ screen without available concerts nearby (an example of which being illustrated in FIG. 7.

It should be understood that, in the middle of the screen there may be a dynamic ad displaying carousel. This section may comprise 6 containers that can be scrolled left-right. Each container may include picture and link to the certain song from a Karaoke Cloud database. Content of these containers can be configured via a Peerpoint backend, the functionality of which being provided by software running on one or more servers accessible via one or more communication networks, as explained above. In accordance with at least one embodiment, launching of a mobile application described above may include a check for available server updates.

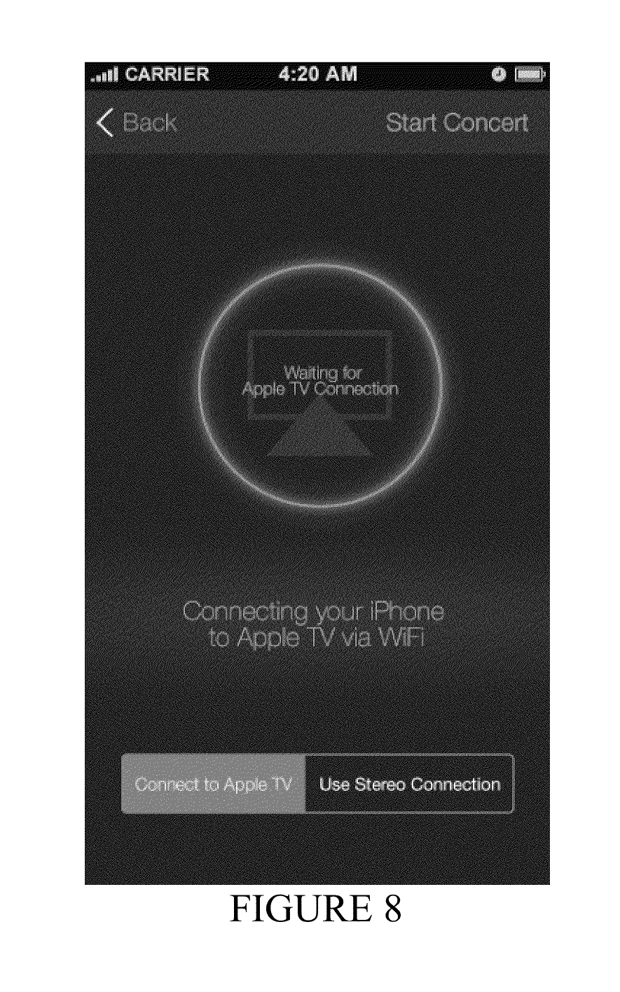

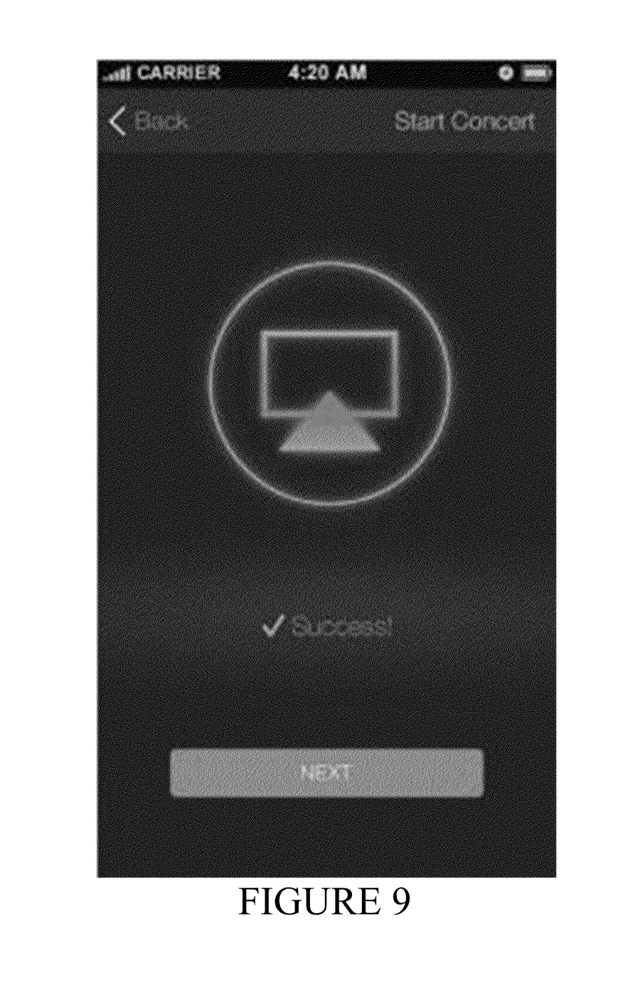

Clicking on a certain container may lead the user to the ‘Library’ screen with the certain song highlighted with the active ‘Upgrade’ button. The user may be able to start a concert by clicking on the ‘Start a Concert’ button. As a result, the user may be redirected to the ‘APPLE TV® Connection’ screen (an example of which being illustrated in FIG. 8). If APPLE TV® is found, the user may be shown a ‘APPLE TV® Connection Success’ message (an example of which being illustrated in FIG. 9).

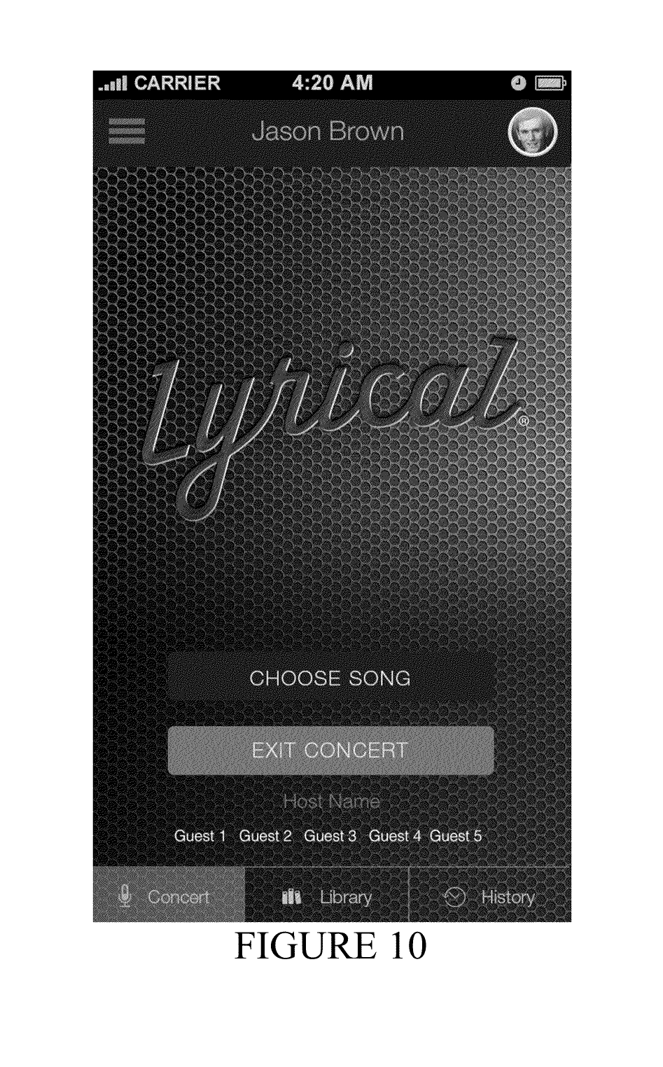

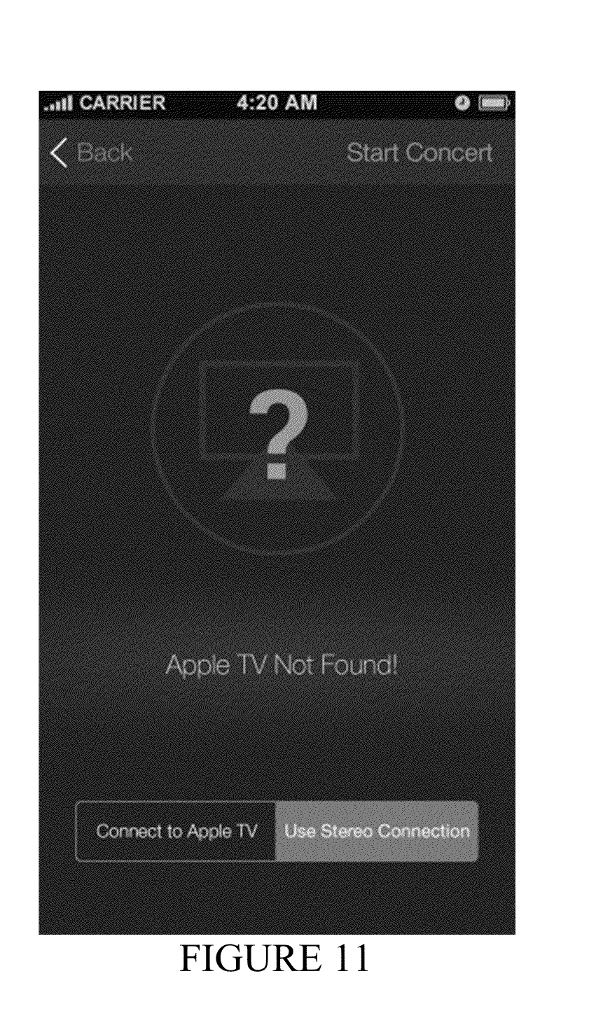

The user may be able to go to the ‘Home’ screen with the active ‘Concert’ tab with the list of Singers and the highlighted Host, ‘Choose Song’ and ‘Leave Concert’ buttons by clicking on the ‘Next’ button (an example of which being illustrated in FIG. 10). If APPLE TV® is not found, the user may be shown the ‘APPLE TV® Not Found’ message (an example of which being illustrated in FIG. 11).

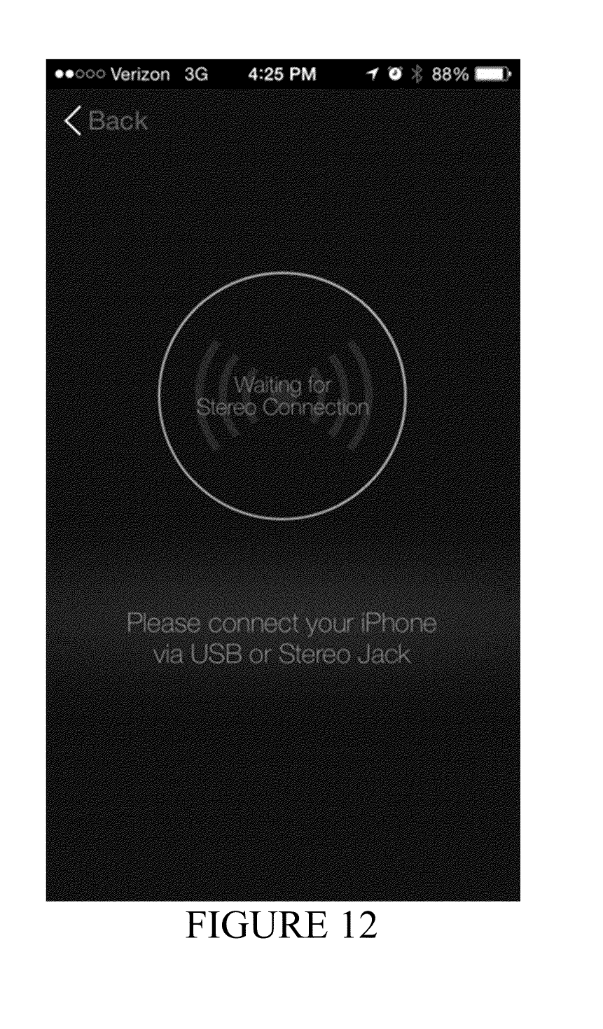

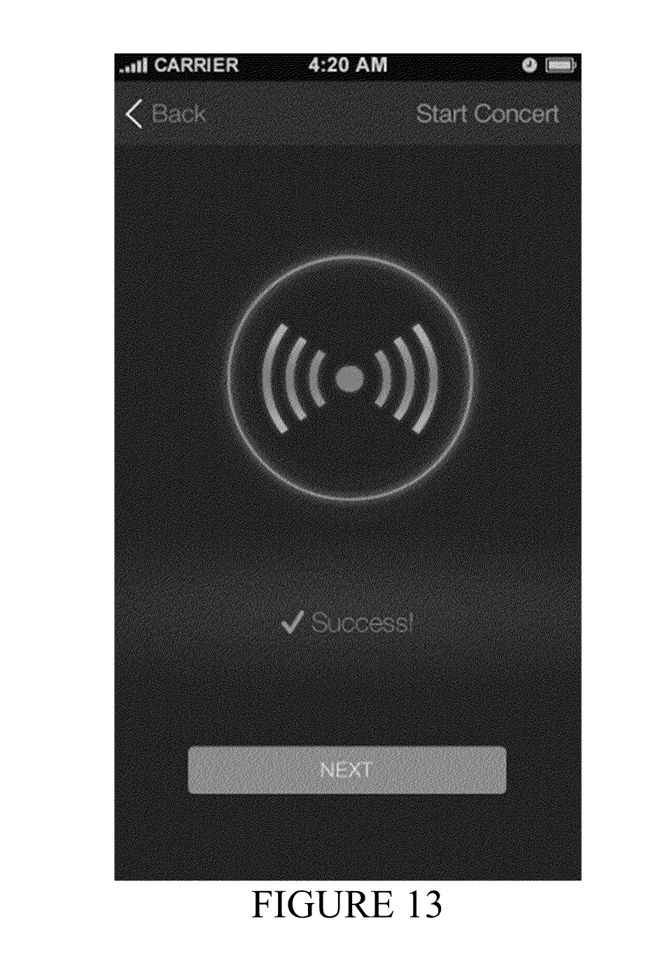

There may be two scenarios. The user may be able to initiate the APPLE TV® Connection process again by clicking on the ‘Connect to APPLE TV®’ button. As a result, the user may be redirected to the ‘APPLE TV® Connection’ screen. (Go to 2). Alternatively, the user may be able to use stereo connection by clicking on the ‘Use Stereo Connection’ button. As a result, the user may be shown the ‘Waiting for Stereo Connection’ message (an example of which being illustrated in FIG. 12). When the stereo connection is established, the user may be shown the ‘Stereo Connection Success’ message (an example of which being illustrated in FIG. 13).

The user may then be able to go to the ‘Home’ screen with the active ‘Concert’ tab with the list of Singers and the highlighted Host, ‘Choose Song’ and ‘Leave Concert’ buttons by clicking on the ‘Next’ button.

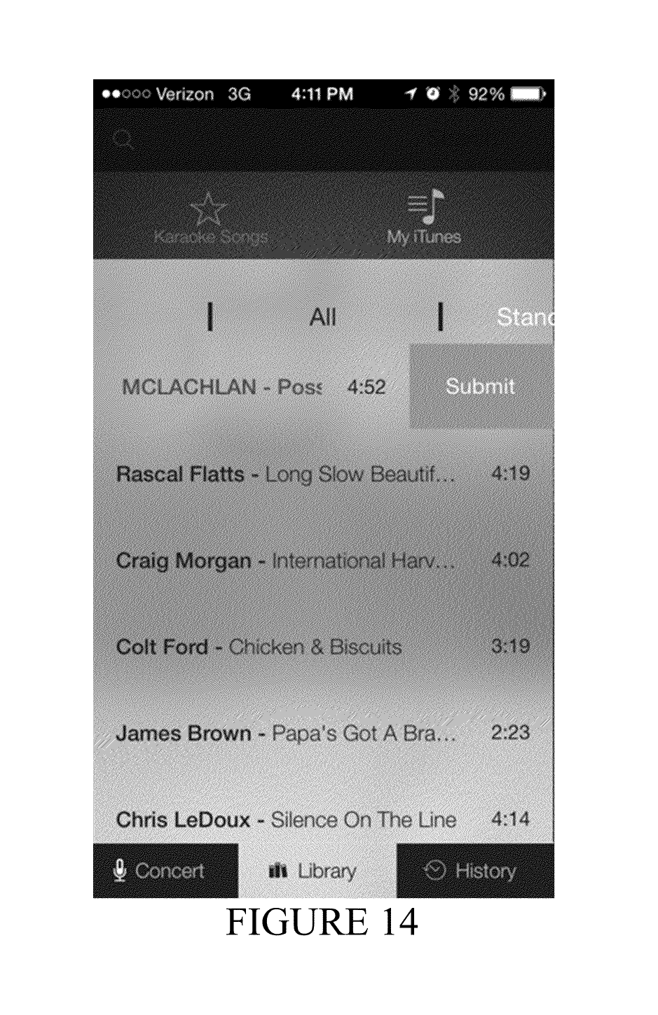

The user may also be able to go to the ‘Library’ screen by clicking on the ‘Choose Song’ button. As a result, the user may be redirected to the ‘Library’ screen (an example of which being illustrated in FIG. 14).

The user may be able to submit a song to the election list by clicking on it. As a result, the user may be redirected to the ‘Election’ screen where he/she may be able to vote for the certain song.

When one of singers initiates the song election process by clicking on the song, the timer may appear on the ‘Concert’ tab and the ‘Election’ screen. While the timer is on, the user may be able to return to the ‘Library’ screen and reselect the song by clicking on the ‘Back’ button. The user may be able to skip the song selection process by clicking on the ‘Skip’ button, which is visible only when the user is in the concert. As a result, the user may be redirected to the ‘Election’ screen where he/she may be able to vote for the certain song.

During this operation, the user also may be able to go to the ‘Library’ screen, where he/she may be able to search and select the certain song or skip to the voting screen by clicking on the same ‘Skip to Vote’ button as pictured in FIG. 14.

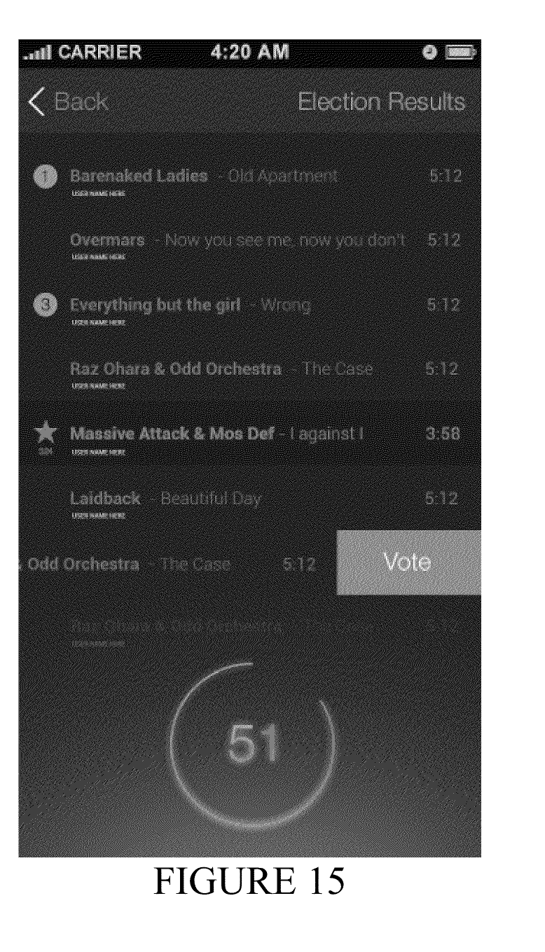

On the ‘Election’ screen, the user may be able to vote for the song by clicking on it and shortly after on the ‘Vote’ button, which may become visible by clicking on the certain song (an example of which being illustrated in FIG. 15).

The user may be able to cancel vote by repeating the same procedure for another song. Additionally, the user may be able to resubmit a song for the election process by clicking on the ‘Back’ button. As a result, the user may be redirected back to the ‘Library’ screen where he/she may be able to select another song.

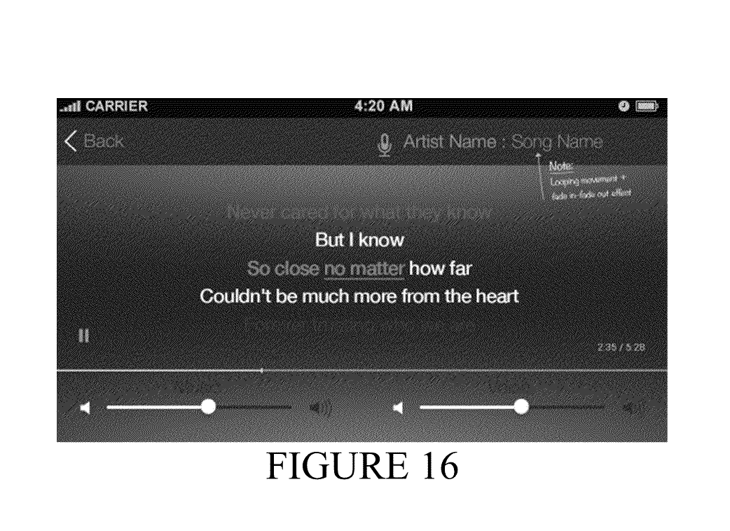

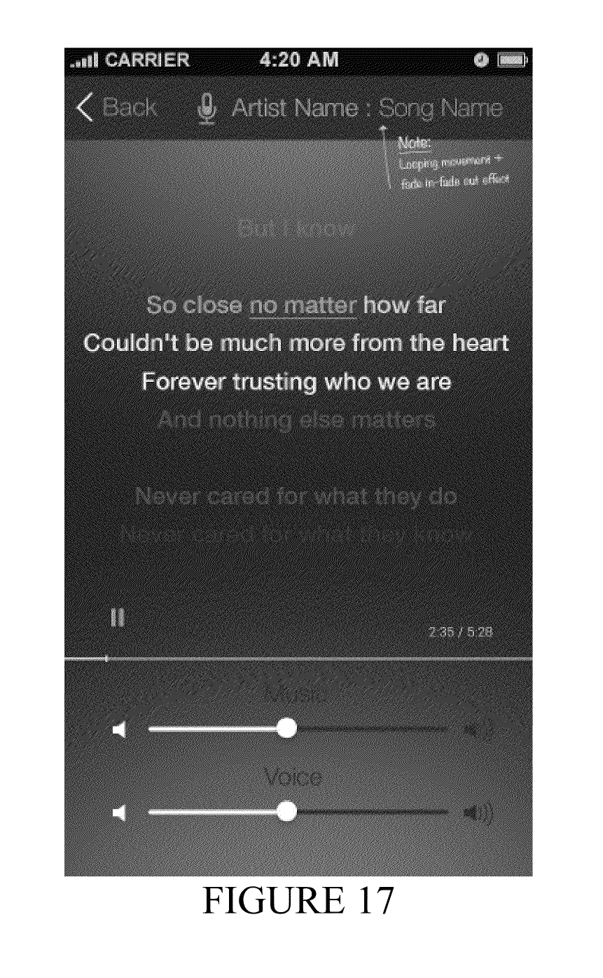

When the timer expires, all the users may be redirected to the countdown from 10. It may be accompanied with visual and audio effects and may be visible on all devices. Note, this countdown delay may be used for transferring the elected song from the device of the user who submitted this song to the Host's one. When the countdown is over, the user may be redirected to the ‘Lyrics’ screen and the music may start. There are two views of the ‘Lyrics’ screen: Landscape View (an example of which being illustrated in FIG. 16) and Portrait View (an example of which being illustrated in FIG. 17). Note, during song playback, only the Host may be able to change music volume. Other users may not be able to see the music volume slider.

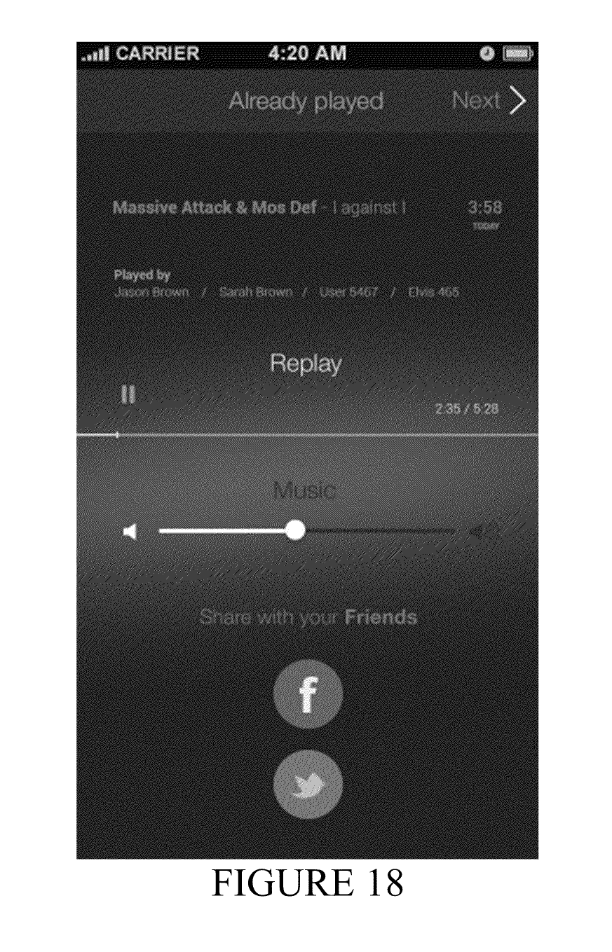

By clicking on the ‘Back’ button, the user may be warned that he/she may exit the concert and may have to join again. If Host exits the concert, the whole group may be disbanded. The corresponding message may be displayed to singers. When the song ends, all users may be redirected to the Post-Song′ screen (an example of which being illustrated in FIG. 18).

The user may be able to go to the ‘Home’ screen with the active ‘Concert’ tab with the list of singers and the highlighted Host, ‘Choose Song’ and ‘Leave Concert’ buttons by clicking on the ‘Next’ button. The user may be able to leave the message about the concert on Facebook® or Twitter® by clicking on the corresponding button, as explained herein.

The user may be able to view the information about the song and the list of the users who sang the song. The user may also be able to listen to the recording and change music volume with the use of corresponding elements.

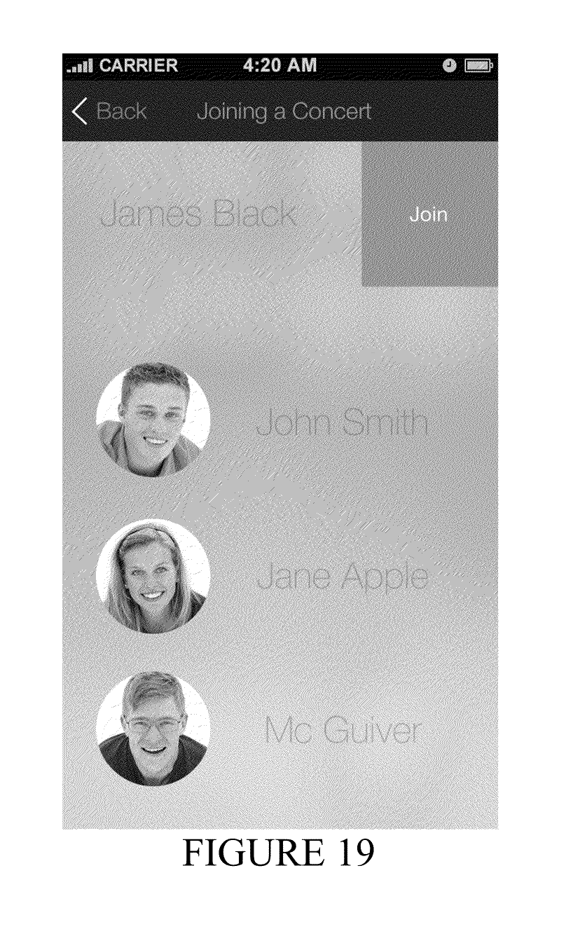

As explained above, the user may be able to join a concert when there is available one. The ‘Concert’ tab may contain the ‘Join a Concert’ button, an example of which being illustrated in FIG. 06. The user may be able to join a concert by clicking on the ‘Join a Concert’ button. As a result, the user may be redirected to the ‘Joining Concert’ screen (an example of which being illustrated in FIG. 19).

On the ‘Joining Concert’ screen user may be able to select the Host's device. The ‘Join the Concert’ button may be enabled, and the user may be able to click on this button to complete the joining procedure. As a result, the user may be redirected to the ‘Home’ screen with the active ‘Concert’ tab with the list of Singers with the highlighted Host, ‘Choose Song’ and ‘Leave Concert’ buttons. Additional operations enabled by the workspace are explained herein in conjunction with starting and participating in a concert.

The user may be able to Upgrade in various ways. For example, the user may be able to start the song purchasing process by clicking on the song on the ‘Library’ screen. As a result, the song time may turn to the ‘Upgrade’ button. The user may be able to complete the Upgrade purchase process by clicking on the ‘Upgrade’ button. If the user hasn't already entered the password to confirm the operation during the current session, the user may be asked to do this with the special pop-up screen with the ‘Password’ text field and two buttons—‘Cancel’ and ‘OK’ buttons. When the Upgrade is purchased, it may be added to the library. The user may be able to view and choose newly bought song on the ‘Library’ tab. Note, the mobile application may use the user's APPLE® ID for purchasing songs from Karaoke Cloud.

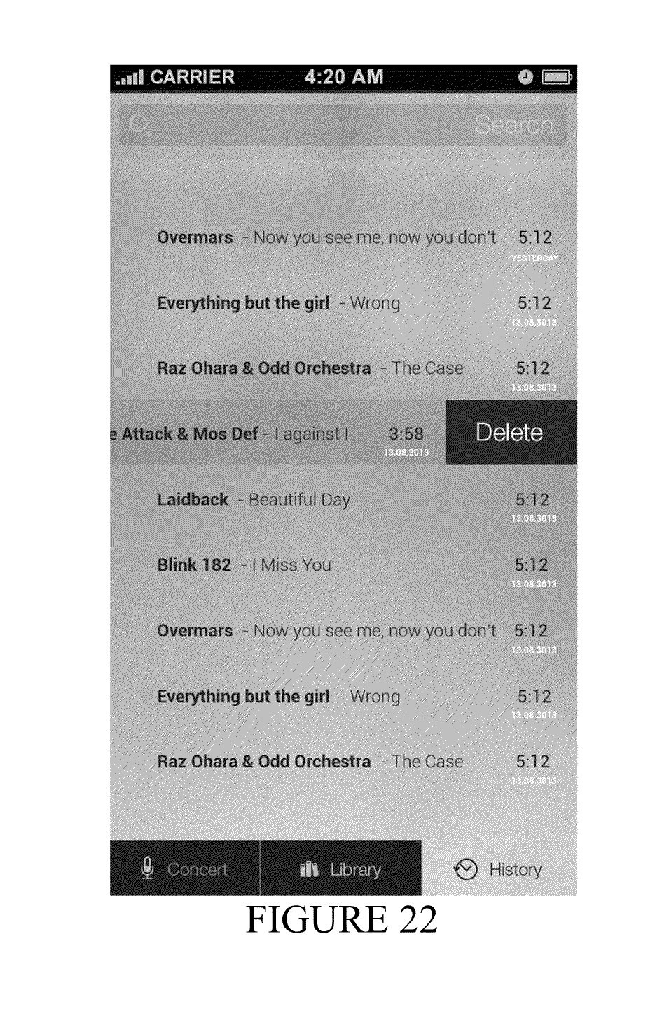

The user may be able to view his/her songs on the ‘Library’ screen (an example of which being illustrated in FIG. 22)

The user may be able to view the list of songs purchased via the application by clicking on the ‘Karaoke Songs’ button. The application may load the ‘Library’ screen with this list presented by default. The user may also be able to view the list of songs purchased via iTunes by clicking on the ‘iTunes’ button. The user may be able to search for the certain song with the use of the search bar located at the top of the screen. The user may be able to listen to a song by clicking on the arrow icon and change volume with iPhone's volume buttons.

If the user clicks on the song, a special pop-up form may be called out. This form may contain following elements: Message—the warning indicating that the user must join or start a concert first, ‘Start’ button—like the ‘Start a Concert’ button, initiates the concert creation process, as explained above—like the ‘Join a Concert’ button, initiates the concert joining process, as explained above. This button is enabled only if there are available concerts nearby, and ‘Not now’ button—closes this form.

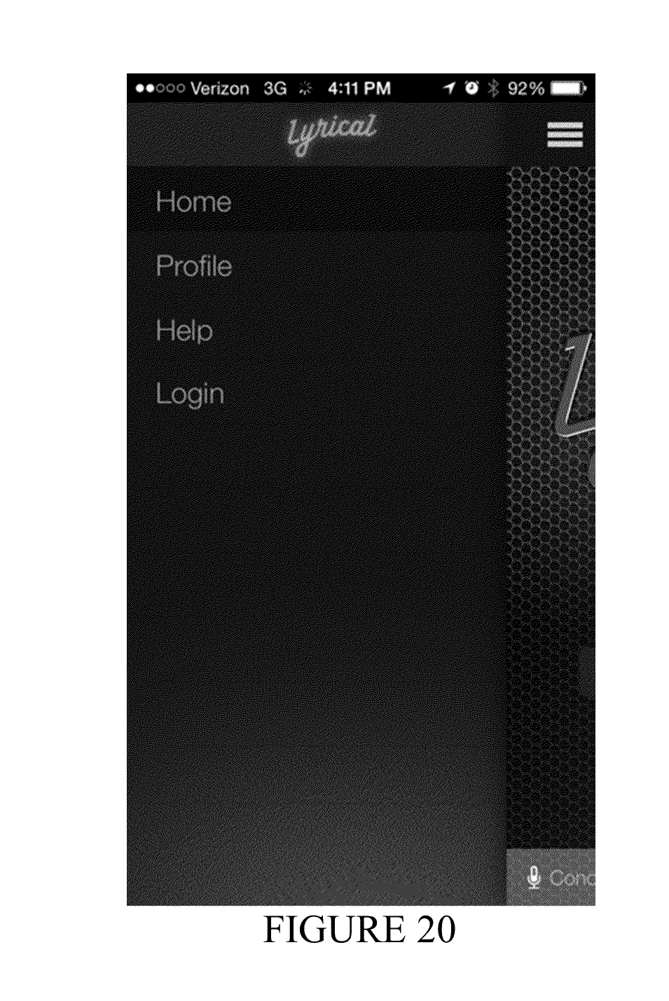

The user may be able to get an access to the application menu by clicking on the ‘Menu’ button on the ‘Home’ screen. This button may be located in the top left corner of the screen, as shown in FIG. 07. As a result, the menu illustrated in FIG. 20 may be displayed.

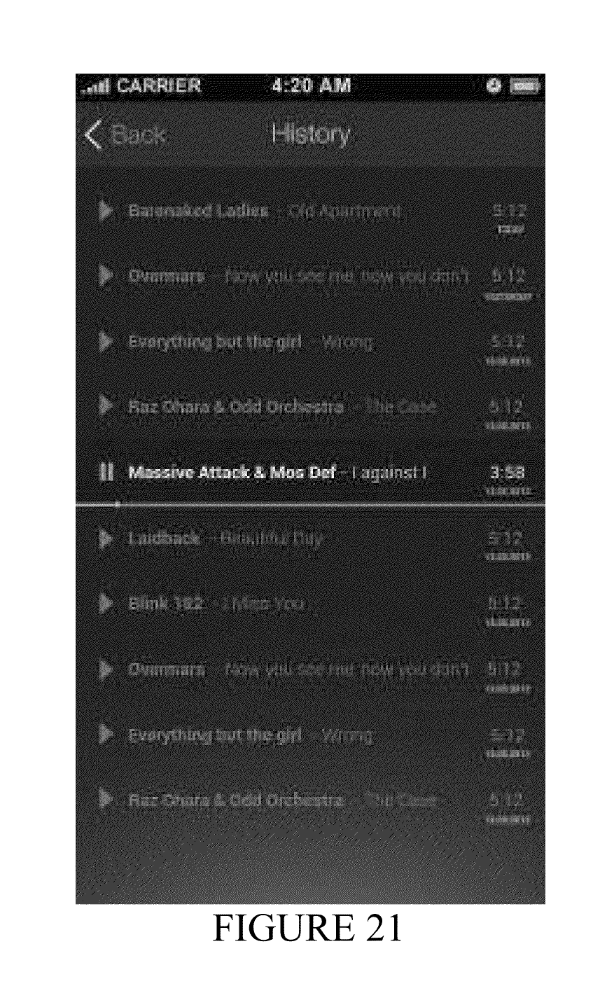

The user may be able to manage the user information in the ‘Profile’ section as explained above in relation to FIG. 4. The user may be able to view concert history by clicking on the ‘History’ menu item. As a result, the user may be redirected to a screen like that illustrated in FIG. 21.

At this position within the workspace, various scenarios are enabled. For example, the user may be able to play a recording by clicking on the arrow icon near the corresponding history item. Additionally, the user may be able to change music volume with the volume slider located at the bottom of the screen. Alternatively, the user may be able to delete a history item by swiping and clicking on the appeared ‘Delete’ button, as illustrated in FIG. 22.

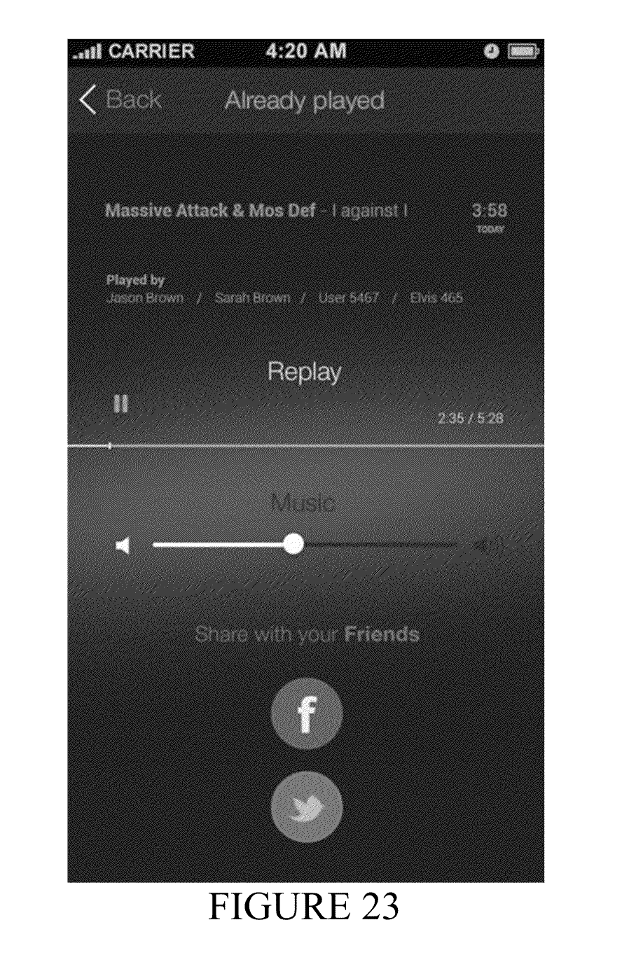

The user may also be able to view history item details by clicking on the song. As a result, the user may be redirected to a ‘History Item’ screen (an example of which being illustrated in FIG. 23). The user may be able to go back to the ‘History’ screen by clicking on the ‘Back’ button. The user may also be able to leave the message about the concert on Facebook® or Twitter® by clicking on the corresponding button. The example of this message: ‘Michael sang What I Got by Sublime with Billy and Ryan’.

At this point within the workspace, various additional scenarios are enabled. For example, if the Facebook® and/or Twitter® connection has already been established with the use of the profile customization feature, this operation may be done automatically by clicking on the corresponding social network button. When it's done, the certain note may appear next to the social network button. This note may indicate that this information has been already shared via this social network.

If the connection with social networks has not been established before, the user may be asked to sign in to his/her Facebook® or Twitter® account. During this procedure the user may be suggested to save these settings for using sharing features in the future.

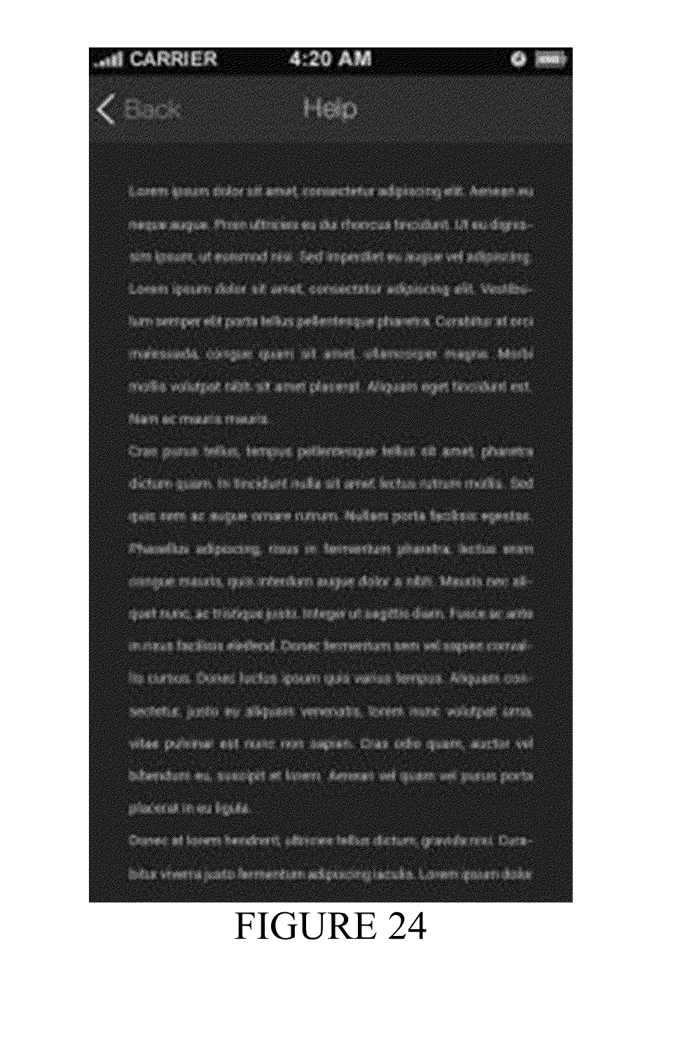

The user may be able to view the information about the song and the list of the users who sang the song. The user may also be able to listen to the recording and change music volume with the use of corresponding elements. The user may be able to delete the history item by clicking on the ‘Delete’ button. The user may also be able to view basic info on use of app, incl. ‘Start a Concert’ and ‘Join a Concert’ processes and differences between them, in a ‘Help’ section (an example of which being illustrated in FIG. 24).

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure.

For example, it should be understood that the disclosed embodiments may be used in conjunction with various different media platforms, e.g., iOS from APPLE® or ANDROID®, etc. Likewise, the disclosed embodiments may be used in conjunction with and obtain content via various different content sources including, for example, one or more streaming media services that may stream single or multimedia. In at least some implementations, that media may be constantly received by and presented to an end-user while being delivered by a provider. Thus, it should be understood that, herein the verb “stream” refers to the process of delivering media in this manner and refers to the delivery method of the medium, rather than the medium itself, and is an alternative to downloading. Disclosed embodiments may be implemented with both streamed and downloaded content.

Further, it should be understood that disclosed embodiments may be configured to be provide audio and video and be compatible with an audio stream compressed using an audio codec such as MP3, Vorbis or AAC, a video stream compressed using a video codec such as H.264 or VP8. Thus, encoded audio and video streams may be assembled in a container bitstream such as MP4, FLV, WebM, ASF or ISMA delivered from a streaming server to a streaming client using a transport protocol, such as MMS or RTP. Furthermore, when handling streaming content, the disclosed embodiments may utilize adaptive bitrate streaming over HTTP using HLS, Microsoft's Smooth Streaming, Adobe's HDS or MPEG-DASH. Further, the mobile application may interact with a streaming service server using a control protocol, such as MMS or RTSP.

The foregoing description, for purpose of explanation, has been described with reference to specific embodiments. In particular, the attached Appendix includes software code that implements one embodiment of the disclosed innovation; however, it should be understood that the Appendix implementation and the above-illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

Various elements, devices, modules and circuits are described above in associated with their respective functions. These elements, devices, modules and circuits are considered means for performing their respective functions as described herein.

While the foregoing is directed to embodiments of the present invention, other and further embodiments of the invention may be devised without departing from the basic scope thereof, and the scope thereof is determined by the claims that follow.

1. A system comprising a mobile application implemented in software code stored and running on a plurality of mobile devices each associated with respective users, wherein:
the mobile application enables coupling of the plurality of mobile devices via a plurality of communication links to establish a collective workspace;
the mobile application code establishes one of the mobile devices as a host device for a particular concert and remaining mobile devices of the plurality of mobile devices as singer devices for that particular concert,
the mobile application code enables coupling of the host device to at least one audio device that outputs, under the control of the mobile application code stored and running on the host device, music for a particular concert, while the mobile application code running on each of the plurality of mobile devices outputs lyrics for the music output on the at least one audio devices, such that the users of the mobile devices perform the concert by singing the music lyrics output on their respective mobile devices while being accompanied by the music output via the at least one audio devices and the mobile application code stored and running on the host device also records the performance of the concert.

2. The system of claim 1, wherein the mobile application code enables the host device share the recorded performance of the concert over the Internet.

3. The system of claim 1, wherein the mobile application code is downloaded to and runs on a plurality of mobile devices including at least one of a tablet, mobile phone, smart phone.

4. The system of claim 1, wherein functionality is at least partly enabled by code running on one or more servers accessible via the plurality of mobile devices via at least one communication network which couples the plurality of mobile devices to the one or more servers.

5. The system of claim 1, wherein the host device is coupled via a communication link to one or more singer devices via a Wireless Local Area Network.

6. The system of claim 1, wherein the host device is coupled via a communication link to one or more singer devices via a cellular network.

7. The system of claim 1, wherein the host device is coupled via a communication link to one or more singer devices via WIFI.

8. The system of claim 1, wherein the host device is coupled via a communication link to one or more singer devices via BLUETOOTH.

9. The system of claim 1, wherein the host device is coupled via a communication link or a wired link to a stereo or general or special purpose computer that is further coupled to one or more speakers.

10. The system of claim 1, wherein the music for the concert is downloaded or streamed to the host device and/or the singing devices.

11. A method for recording a performance of a concert using a plurality of mobile devices each associated with respective users, the method comprising:
a mobile application code running on each of the plurality of mobile devices, the mobile application being configured to couple the plurality of mobile devices via a plurality of communication links to establish a collective workspace;
establishing, using the mobile application code, one of the mobile devices as a host device for a particular concert and remaining mobile devices of the plurality of mobile devices as singer devices for that particular concert,
coupling, using the mobile application code, the host device to at least one audio device that outputs, under the control of the mobile application code stored and running on the host device, music for a particular concert, while the mobile application code running on each of the plurality of mobile devices outputs lyrics for the music output on the at least one audio devices, such that the users of the mobile devices perform the concert by singing the music lyrics output on their respective mobile devices while being accompanied by the music output via the at least one audio devices and the mobile application code stored and running on the host device also records the performance of the concert.

12. The method of claim 1, wherein the mobile application code enables the host device to share the recorded performance of the concert over the Internet.

13. The method of claim 1, wherein the mobile application code is downloaded to and runs on a plurality of mobile devices including at least one of a tablet, mobile phone, smart phone.

14. The method of claim 1, wherein functionality is at least partly enabled by code running on one or more servers accessible via the plurality of mobile devices via at least one communication network which couples the plurality of mobile devices to the one or more servers.

15. The method of claim 1, wherein the host device is coupled via a communication link to one or more singer devices via a Wireless Local Area Network.

16. The method of claim 1, wherein the host device is coupled via a communication link to one or more singer devices via a cellular network.

17. The method of claim 1, wherein the host device is coupled via a communication link to one or more singer devices via WIFI.

18. The method of claim 1, wherein the host device is coupled via a communication link to one or more singer devices via BLUETOOTH.

19. The method of claim 1, wherein the host device is coupled via a communication link or a wired link to a stereo or general or special purpose computer that is further coupled to one or more speakers.

20. The method of claim 1, wherein the music for the concert is downloaded or streamed to the host device and/or the singing devices.
